(19) United States
(12) Patent Application Publication
(10) Pub. No.: US 2014/0282839 A1
(43) Pub. Date: Sep. 18, 2014

(54) UNIFIED ENTERPRISE DEVICE ENROLLMENT

(71) Applicant: MICROSOFT CORPORATION, Redmond, WA (US)

(72) Inventors: Zhi Cai, Redmond, WA (US); Monty Jain, Redmond, WA (US); Alexei Boudzko, Redmond, WA (US); Gunnar Kudrjavets, Kirkland, WA (US); Yuhang Zhu, Bellevue, WA (US); Daniel Kevin McBride, Redmond, WA (US); Clifford Paul Strom, Sammamish, WA (US)

(73) Assignee: Microsoft Corporation, Redmond, WA (US)

(21) Appl. No.: 13/842,660

(22) Filed: Mar. 15, 2013

(51) Int. Cl. H04L 29/06

(52) U.S. Cl. CPC H04L 63/08; H04L 63/20
USPC 726/1; 726/4

(57) ABSTRACT

A unified enrollment client is described that allows authentication and communication with disparate enterprise management source types. A first enterprise management source type can have a corporate-based management server which is on the premises of the corporation. A second enterprise management source type can have a cloud-based management server in which a corporate server communicates through a federation gateway to a cloud-based management server. Authentication can be handled regardless of the source type through the use of a discovery request which identifies the source type so that the enrollment client knows how to tailor the authentication, if any is needed, to the particular enterprise management source.

### BACKGROUND

An enterprise application is the term used to describe software applications that businesses use to assist in solving problems. In today's corporate environment, enterprise applications are complex, scalable, distributed, component-based, and mission-critical. They may be deployed on a variety of platforms, across corporate networks, intranets, or the Internet. They are often data-centric, user-friendly, and must meet stringent requirements for security, administration, and maintenance. Examples of enterprise applications can include a sales applications, marketing applications, business intelligence tools, project management applications, etc. In short, enterprise applications can be directed to applications that a business wants its employees to use.

As mobile devices become more prevalent, users want to use their personal devices in conjunction with business. For example, rather than users owning a business phone and a separate personal phone, users own a single phone with integrated business applications and data and personal applications and data.

When enrolling applications or policies on the user's phone, different enterprise source types can cause authentication problems. For example, some enterprise sources have an on-premise management server, while other enterprise sources have a hosted, cloud-based solution. The different enterprise source types make enrollment difficult.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A unified enrollment client is described that allows authentication and communication with disparate enterprise management source types. A first enterprise management source type can have an on-premise authority, which is a server computer on the premises of the corporation. A second enterprise management source type can have a cloud-based management server in which a federation authority is used to communicate with a cloud-based management source. Authentication can be handled regardless of the source type through the use of a discovery request which identifies the source type so that the enrollment client knows how to tailor the authentication to the particular enterprise management source.

In one embodiment, an enrollment client can transmit a discovery request to an enterprise management source in order to determine a source type. The source type can be a on-premise management server or a cloud-based management server. In any event, the enterprise management source can respond to the discovery request with a response that identifies its' type. The type relates to the network structure at the enterprise management source. For the on-premise management server, credentials are sent by an enrollment client without the need for authentication. However, for the cloud-based management server, an authentication client is used to perform an authentication.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile device having an enrollment client that can make discovery requests in order to determine a source type of an enterprise management source.

FIG. 2 is a system diagram showing the enrollment client and different types of enterprise management sources.

FIG. 3 shows further details of an enrollment client as including an authentication client and a discovery client.

FIG. 4 is a flowchart of an embodiment for enrolling an enterprise management source.

FIG. 5 is a flowchart of another embodiment for enrolling an enterprise management source.

FIG. 6 is an exemplary cloud environment in which enrollment can be used across multiple devices.

FIG. 7 is an exemplary computing environment that can store software to implement the embodiments herein.

### DETAILED DESCRIPTION

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs that are separately stored in application containers 114. The application programs can include common mobile computing applications (e.g., email applications, calendars, contact managers, web browsers, messaging applications), or any other computing application. A particular application program 115 can be used for policy and application enrolling an enterprise management source. The application 115 can make discovery requests to determine a network configuration of an enterprise management source, as further described below.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device. The input devices 130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 112 or applications can comprise speech-recognition software as part of a voice user interface that allows a user to operate the device 100 via voice commands. Further, the device 100 can comprise input devices and software that allows for user interaction via a user's spatial gestures, such as detecting and interpreting gestures to provide input to a gaming application.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can be deleted and other components can be added.

FIG. 2 is an example system diagram illustrating an enrollment client and multiple policy setting providers. Multiple enterprise management sources 1 through N (shown at 210, 212) (where N is any integer value) can be server computers associated with multiple companies. The enterprise sources 210, 212 can have different policies associated with a function on a computer device 216. Example functions can include password-related features (e.g., whether a password is required, length of a password, complexity, expiration, history, incorrect entry threshold, idle time allowed before lock, etc.) Other functions can relate to whether a storage card is allowed, encryption, etc. The computer device 216 can be a mobile device, such as a mobile phone, or other computer device described herein. An enrollment client 220 can receive a policy from one of the enterprise management sources together with a provider identification to indicate which source is associated with the policy. Based on the policy, the enrollment client 220 selects an appropriate policy provider, such as device lock provider 230, or other policy setting providers 232. The device lock provider 230 controls policy functions related to a password, while the other policy setting providers (which can include one or more providers) control all other policies. The device lock provider 230 can have an associated table shown at 240 that lists the provider identifications and the associated policy for each provider. Although the enrollment client is only illustrated for enrolling policy information, it can also enroll applications or other content from the enterprise management source. Additionally, although not shown in FIG. 2, the computer device 216 can have a user interface (e.g., such as shown in FIG. 1) for receiving a user's credentials and sending the user's credentials to the enrollment client 220.

The enterprise management sources 210, 212 can have different network structures. For example, enterprise management source 210 can include an on-premise authority. Consequently, it can be a corporate network based management server. Thus, for such a server computer, a federated authority is not needed, nor is an organization identifier needed for use by the federated authority. Enterprise management source 212, by contrast, has a different network structure. In particular, the management source 212 communicates with the enrollment client 220 through a federated authority 270. Such communication does require authentication that is not needed with the on-premise authority 210. Both the management source 210 and the cloud-based management source 212 have a discovery service shown at 278, 280, respectively. The federated authority is a known structure in the art. Federation refers to the underlying trust infrastructure that supports federated sharing, an easy method for sharing information with recipients in other external federated organizations. The federated authority 270 is a cloud-based service that acts as a trust broker between an on-premise organization and other federated organizations. To configure federation in an on-premise organization, a one-time federation trust can be established. With this trust in place, users that are authenticated are issued Security Assertion Markup Language (SAML) delegation tokens by the federated authority 270. These delegation tokens allow users from one federated organization to be trusted by another federated organization. With the federated authority 270 acting as the trust broker, organizations are not required to establish multiple individual trust relationships with other organizations, and users can access external resources using a single sign-on experience. A federated organization identifier (OrgID) defines which of the authoritative accepted domains configured in an organization are enabled for federation. Recipients that have e-mail addresses with accepted domains configured in the OrgID are recognized by the federation gateway and are able to use federated sharing features. The OrgID is a combination of a pre-defined string and the accepted domain selected as the primary shared domain.

FIG. 3 shows additional details of the enrollment client 220. In particular, the enrollment client 220 includes a discovery client 310 and an authentication client 320. Although each of the clients 310, 320 are shown integrated into the enrollment client, one or both can be separate. The discovery client 310 is used to determine a type of the source 210 or 212 with which the enrollment client 220 is communicating. In particular, a discovery request can be sent to one of the destination enterprise management sources 210, 212. The discovery services 278, 280 each can receive and respond to their respective discovery request. A response can be received that indicates the source type. The source types can be an on-premise management server or a cloud-based management server. The embodiments described herein can be extended to other types of sources, as is well understood in the art. The on-premise management source 210 receives a credential, such as a domain credential, and does not need further authentication. By contrast, the cloud-based enterprise management source 212 does require further authentication. Authentication can then be performed using the authentication client 320, which takes into consideration the type of source identified through the discovery request. Authentication with the source 212 can require the use of the organization identifier. Once authenticated, the enrollment client 220 can communicate with the source in order to receive policy information as described above. Enrollment can further be extended to applications supported by the enterprise sources.

FIG. 4 is a flowchart of a method for enrolling different enterprise sources with a client device. In process block 410, a discovery request is transmitted from an enrollment client to an enterprise management source in order to determine a source type. The source type is based on the network configuration associated with the enterprise management source. From the perspective of the client device, the enterprise management source is a simple DNS address with which to communicate. Thus, to the client device, in terms of communicating the discovery request, with the enterprise management sources, each source looks the same. In process block 420, a discovery response is received that identifies the source type. The client device has logic contained therein to perform an authentication, if needed. For example, if the source type is on premise, then authentication is not needed through the federated authentication client 320. However, is the source type is a cloud-based management source 212, then the federated authentication client 320 is used to complete authentication.

FIG. 5 is a flowchart of a method for enrolling different enterprise source types according to another embodiment. In process block 510, a unified enrollment client can be provided that can couple to disparate enterprise sources having different authentication requirements. For example, some sources require authentication steps not required by other sources. The enrollment client is unified because only one enrollment client can be used for two or more source types. In process block 520, a discovery request is first transmitted to an enterprise source asking for the type of source. In process block 530, a discovery response is received indicating that the first enterprise source has a first authentication requirement. The first authentication requirement can be that no further authentication is required. Instead, a domain credential can be sufficient. In process block 550, a discovery request is transmitted to a second enterprise source, which is of a different type than the first enterprise source. In process block 560, a discovery response is received indicating that the second enterprise source requires a second authentication requirement, which has a different protocol than the first authentication requirement. For example, if a federated authority is used, a domain credential can be converted to an organizational identifier for purposes of authentication. In process block 570, the second enterprise source is authenticated using the second authentication requirement, such as by using an authentication client. Thus, depending on the source type obtained through a discovery request, an authentication client can be used for authentication or not.

FIG. 6 illustrates a generalized example of a suitable implementation environment 600 in which described embodiments, techniques, and technologies may be implemented.

In example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, personal digital assistant, tablet computer, or the like. Connected device 650 represents a device with a large screen 655. For example, connected device 650 could be a television screen (e.g., a smart television) or another device connected to a television (e.g., a set-top box or gaming console) or the like. One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, the service providers 620 can provide a centralized solution for various cloud-based services. In one embodiment, an enrollment client 622 can be available to enroll an enterprise with connected devices 630, 640, 650. The enrollment client 622 can be a server computer with a list of all user devices associated with a common user account. If the server 622 enrolls a new enterprise to one of the devices, the method described herein can be applied to all of the devices.

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.).

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. For video encoding, the input device(s) 750 may be a camera, video card, TV tuner card, or similar device that accepts video input in analog or digital form, or a CD-ROM or CD-RW that reads video samples into the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., optical media discs, volatile memory components (such as DRAM or SRAM), or nonvolatile memory components (such as flash memory or hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of enrolling different enterprise source types with a client device, comprising:
from an enrollment client, transmitting a discovery request to an enterprise management source in order to determine a source type;
receiving a discovery response that identifies the source type;
performing authentication for enrollment if authentication is needed for the received source type.

2. The method of claim 1, wherein a first source type includes an on-premise corporate network, and a second source type is a hosted, cloud-based network, and wherein the on-premise corporate network does not require authentication whereas the cloud-based network does require authentication.

3. The method of claim 2, further including receiving a same user input whether the enrollment is for the first or second source types.

4. The method of claim 2, wherein the first source type requires a domain credential and the second source type requires authentication credentials.

5. The method of claim 1, further including after authentication, receiving a policy to control the client device.

6. The method of claim 1, wherein the client device is a mobile phone.

7. The method of claim 1, wherein if the source type is cloud-based, then performing a first authentication type and if the source type is corporate-network based then performing a second authentication type, different than the first authentication type.

8. The method of claim 7, wherein for the first authentication type, an organization identifier is generated in order to authenticate the source and wherein for the second authentication type, authentication is not needed.

9. A method of enrolling different enterprise source types with a client device, comprising:
providing a unified enrollment client that can couple to enterprise sources having different authentication requirements;
transmitting a discovery request to a first enterprise source;
receiving a discovery response indicating that the first enterprise source requires a first authentication requirement;
transmitting a discovery request to a second enterprise source;
receiving a discovery response indicating the that the second enterprise source has a second authentication requirement, different than the first enterprise requirement; and
authenticating the second enterprise source using the second authentication requirement.

10. The method of claim 9, wherein the first enterprise source includes an on-premise corporate network, and the second enterprise source includes a hosted, cloud-based network, and wherein the on-premise corporate network does not require authentication.

11. The method of claim 9, further including receiving a same user input whether the enrollment is for the first enterprise source or the second enterprise source.

12. The method of claim 9, further including after authentication, receiving a first policy to control the client device from the first enterprise source and a second policy to control the client device from the second enterprise source.

13. The method of claim 9, wherein the client device is a mobile phone.

14. The method of claim 9, wherein if the source type is cloud-based, then generating an organization identification and if the source type is corporate-network based then generating an organization identifier is not performed.

15. A system for enrolling different enterprise source types on a client device, comprising:
an enrollment client including a discovery client that transmits a discovery request to determine a source type and an authentication client to authenticate the source type based on a discovery response; and
a policy control coupled to the enrollment client for storing policies in association with provider identifications, wherein the policy control determines which of the stored policies to apply.

16. The system of claim 15, wherein the client device is a mobile phone.

17. The system of claim 15, further including a user interface for receiving a user's credentials and sending the user's credentials to the enrollment client.

18. The system of claim 15, wherein the source type is based on whether an enterprise management source includes a corporate-network based management server or a cloud-based management server.

19. The system of claim 18, wherein the cloud-based management server uses an organization identifier for authentication, and the corporate-network based management server does not use the organization identifier.

20. The system of claim 18, wherein only one enrollment client is used for both source types.
